(19) United States
(12) Patent Application Publication
(10) Pub. No.: US 2026/0120419 A1
(43) Pub. Date: Apr. 30, 2026

(54) GARMENT RECOVERY FROM HUMAN SCANS

(71) Applicant: Meta Platforms Technologies, LLC, Menlo Park, CA (US)

(72) Inventors: Tuur Jan M Stuyck, San Francisco, CA (US); Yifei Li, Cambridge, MA (US); Hsiao-yu Chen, Austin, TX (US); Egor Larionov, San Francisco, CA (US); Nikolaos Sarafianos, Castro Valley, CA (US)

(21) Appl. No.: 19/049,397

(22) Filed: Feb. 10, 2025

Related U.S. Application Data
(60) Provisional application No. 63/552,759, filed on Feb. 13, 2024.

(51) Int. Cl. G06T 19/20; G06T 7/73; G06V 10/26; G06V 20/64

(52) U.S. Cl. CPC G06T 19/20; G06T 7/74; G06T 7/75; G06V 10/26; G06V 20/647; G06T 2207/30196; G06T 2210/16; G06T 2219/2021

(57) ABSTRACT

A method for extracting clothing assets includes receiving three-dimensional (3D) scan data characterizing a person wearing a garment, and processing the scan data to simultaneously (i) identify from the scan data an initial garment pattern and garment material, and (ii) extract from the scan data an initial pose and an initial body shape. The method further includes performing a simulation process based on the initial garment pattern, the garment material, the initial pose, and the initial body shape, to compute an initial 3D garment state. The method further includes performing an optimization process on the initial 3D garment state to simultaneously modify one or more of the initial garment pattern, the garment material, the initial pose, and the initial body shape, resulting in an optimized 3D garment state. The method further includes extracting, from the optimized 3D garment state, an optimized garment pattern.

### CROSS-REFERENCE OF RELATED APPLICATION

This application claims the benefit of U.S. Provisional Application No. 63/552,759, filed on Feb. 13, 2024, and which is incorporated herein in its entirety.

### TECHNICAL FIELD

The present disclosure generally relates to virtual reality, and more particularly to simulation of clothing of user avatars in virtual reality.

### BACKGROUND

Clothing plays an important role for self-expression, both in the real world and in telepresence applications. The realism of digital avatars enables telepresence applications with self-expression and customization. An aspect of this realism comes from the physical accuracy of both a true-to-life body shape and clothing. While physical simulations can produce high-quality, realistic motions for clothed humans, they require precise estimation of body shape and high-quality garment assets with associated physical parameters for cloth simulations. However, manually creating these assets and calibrating the parameters is labor-intensive and requires specialized expertise. The conventional approach requires meticulous manual design by artists, a process that is exceedingly time-consuming. This manual approach is fundamentally unfeasible for individualized avatar clothing, especially considering the continuously growing user base of telepresence applications. The notion of having an artist create a unique virtual outfit for every user is simply impractical.

Recent advancements in computer vision and graphics have enabled some automation of avatar asset creation from user images or scans. However, the predominant focus has been on geometry reconstruction, with limited focus on generating complete assets that can be used in physics-based applications.

Accordingly, there is a need for automated solutions for scalable and personalized avatar asset creation and optimization.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for extracting clothing assets. The method also includes receiving three-dimensional (3D) scan data characterizing a person wearing a garment; processing the scan data to simultaneously (i) identify from the scan data an initial garment pattern and garment material, and (ii) extract from the scan data an initial pose and an initial body shape; performing a simulation process based on the initial garment pattern, the garment material, the initial pose, and the initial body shape, to compute an initial 3D garment state; performing an optimization process on the initial 3D garment state to simultaneously modify one or more of the initial garment pattern, the garment material, the initial pose, and the initial body shape, resulting in an optimized 3D garment state; and extracting, from the optimized 3D garment state, an optimized garment pattern. Other embodiments of this aspect include corresponding computer systems, apparatus, and computer programs recorded on one or more computer storage devices, each configured to perform the actions of the methods.

One general aspect includes a non-transitory computer-readable medium storing a program for extracting clothing assets. The non-transitory computer-readable medium also includes receive three-dimensional (3D) scan data characterizing a person wearing a garment; process the scan data to simultaneously (i) identify from the scan data an initial garment pattern and garment material, and (ii) extract from the scan data an initial pose and an initial body shape; perform a simulation process based on the initial garment pattern, the garment material, the initial pose, and the initial body shape, to compute an initial 3D garment state; perform an optimization process on the initial 3D garment state to simultaneously modify one or more of the initial garment pattern, the garment material, the initial pose, and the initial body shape, resulting in an optimized 3D garment state; and extract, from the optimized 3D garment state, an optimized garment pattern, where the optimization process uses differentiable simulation. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement extraction of clothing assets, according to some embodiments.

FIG. 2 is a block diagram illustrating details of a system for extraction of clothing assets, according to some embodiments.

FIG. 3 illustrates an automated computational technique of some embodiments to recover simulation-ready garment and body assets.

FIG. 4 illustrates a pipeline to generate simulation-ready avatar assets from inputs obtained through a multi-view capture, according to some embodiments.

FIG. 5A illustrates seam length regularization, according to some embodiments.

FIG. 5B illustrates control cage vertex points and pattern space coordinates for a 2D panel, according to some embodiments.

FIG. 6 illustrates a comparison of 2D patterns generated from some embodiments to artist-made patterns and those generated from previous solutions.

FIG. 7 illustrates body shape and cloth material estimation, according to some embodiments.

FIG. 8 illustrates qualitative comparisons between the optimized output of some embodiments and other techniques.

FIG. 9 illustrates the results of an ablation study, according to some embodiments.

FIG. 10 is a flowchart illustrating a process for extracting clothing assets, according to some embodiments.

FIG. 11 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

“Virtual avatars” or “avatars,” as used herein, refers to digital representations of users in virtual environments, allowing individuals to create customizable and personalized 3D graphical representations of themselves or fictional characters. Virtual avatars are increasingly gaining importance as they serve as a digital extensions of users, enabling novel social and professional interactions. The physical realism of avatars, including realistic clothing and accurate body shape, is crucial for such applications. This need for realism extends beyond visual aesthetics but also includes dynamic interactions and motion obtained by accurate physical simulation of clothing and body dynamics.

“Differentiable simulation,” as used herein, refers to a mathematical operation that allows for gradient computation with respect to simulation parameters, enabling the use of gradient-based optimization algorithms to find solutions for inverse design and system identification.

Some embodiments extract simulation-ready, high-quality clothing assets from 3D scans of clothed humans automatically. Some embodiments perform body and garment co-optimization using differentiable simulation. By integrating physical simulation into the optimization loop, our framework not only recovers body and garment assets but also extracts important material and simulation parameters for downstream physical simulation, enhancing the authenticity and utility of avatar assets.

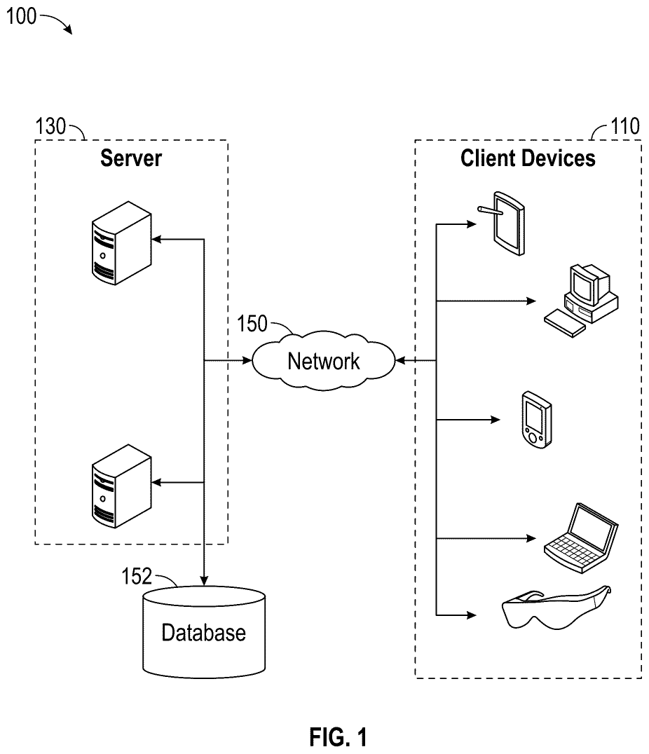

FIG. 1 illustrates a network architecture 100 used to implement extraction of clothing assets, according to some embodiments. The network architecture 100 may include one or more client devices 110 and servers 130, communicatively coupled via a network 150 with each other and to at least one database, e.g. database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

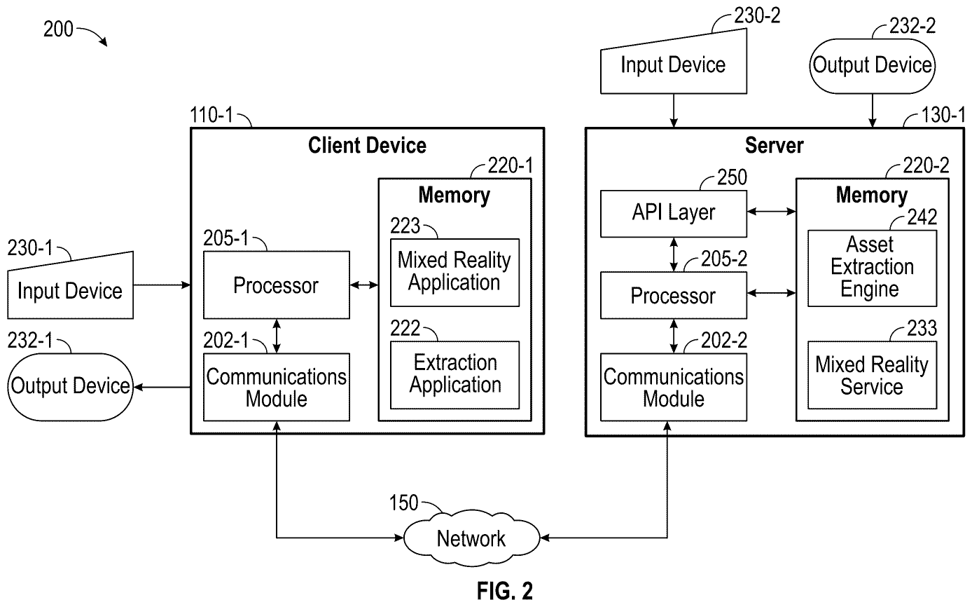

FIG. 2 is a block diagram illustrating details of a system 200 for extraction of clothing assets, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an asset extraction application 222, configured to execute on client device 110-1 and couple with input device 230-1 and output device 232-1. The asset extraction application 222 may be downloaded by the user from server 130-1, and/or may be hosted by server 130-1. The asset extraction application 222 may include specific instructions which, when executed by processor 205-1, cause operations to be performed consistent with embodiments of the present disclosure. In some embodiments, the asset extraction application 222 runs on an operating system (OS) installed in client device 110-1. In some embodiments, asset extraction application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an asset extraction engine 242. The asset extraction engine 242 may be configured to perform methods and operations consistent with embodiments of the present disclosure. The asset extraction engine 242 may share or provide features and resources with the client device 110-1, including data, libraries, and/or applications retrieved with asset extraction engine 242 (e.g., asset extraction application 222). The user may access the asset extraction engine 242 through the asset extraction application 222. The asset extraction application 222 may be installed in client device 110-1 by the asset extraction engine 242 and/or may execute scripts, routines, programs, applications, and the like provided by the asset extraction engine 242.

Memory 220-1 may further include a mixed reality application 223, configured to execute in client device 110-1. The mixed reality application 223 may communicate with a mixed reality service 233 in memory 220-2 to provide a mixed reality environment or experience to a user of client device 110-1. The mixed reality application 223 may communicate with mixed reality service 233 through API layer 250, for example.

### 1. Introduction

Some embodiments provide a computational technique to automatically recover simulation-ready avatars, complete with clothing from multi-view capture setup. Some embodiments utilize differentiable simulation to optimize for assets in a physically plausible way and are capable of recovering clothing patterns and material as well as body pose and shape using a body and garment co-optimization pipeline. For example, the dynamics of the clothing may be retrieved by combining physical simulation within the optimization loop.

In some embodiments, optimized outputs of the pipeline both recover assets for the body and garments and also retrieve physical material parameters that may be used as inputs for physical simulators deployed in downstream applications.

Some embodiments utilize differentiable simulation for co-optimizing garment shape and materials, and body shape and pose, while taking into account cloth deformations and collisions in the context of avatar asset recovery.

Some embodiments provide a unified computational method for body shape, pose, and garment assets co-optimization from a single potentially incomplete or noisy 3D scan of a clothed person.

Some embodiments utilize a differentiable control cage representation which regularizes the domain in the 2D garment pattern space and produces effective optimization results.

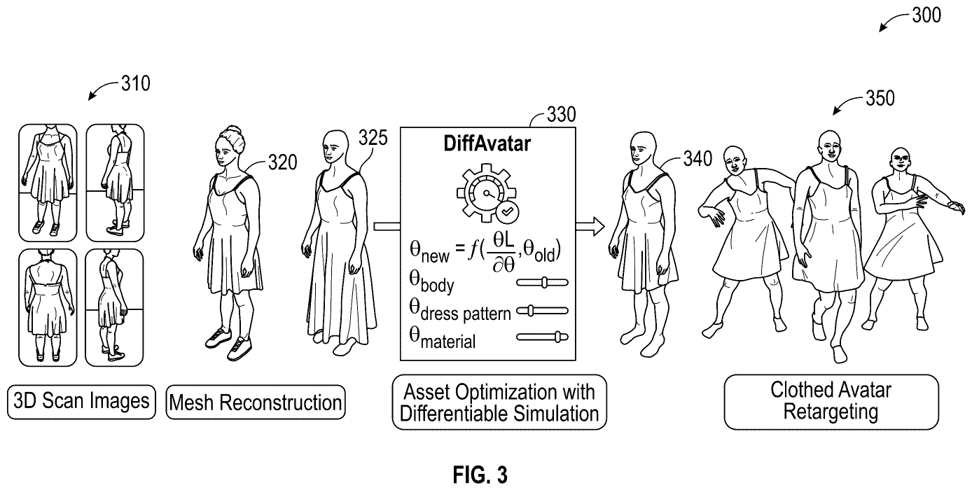

FIG. 3 illustrates an automated computational technique 300 of some embodiments to recover simulation-ready garment and body assets. Starting from a multi-view capture 310, a semantically segmented 3D mesh 320 is reconstructed. The segmented clothing geometry acts as a target shape 325 for the optimization pipeline 330. The technique recovers body shape and pose, clothing pattern, and clothing material parameters from a single scan. A clothing template 340 is optimized in 2D pattern space to reproduce the captured clothing in 3D in a physical way, for different poses 350. Gradients of required parameters are computed using a differentiable simulation approach.

### 2. Related Work

Pose and Shape Estimation precedes the garment shape estimation and its properties since the underlying body directly impacts how cloth drapes and behaves when in motion. Prior works focus on reconstructing the body from naked or minimally clothed [2, 37] captures or focus on complex captures of clothed humans [3, 10, 33, 34, 65] to extract a representation for body and garments. These methods build on SMPL [37], and work in conjunction with simulated [3, 33, 34, 65] or trained [10] garment models.

Cloth Simulation methods have been widely used for digitally modeling the behavior of fabrics in visual effects and movie productions since the pioneering work on implicit cloth simulation [4] and follow-up works [12, 17, 20] allowing for stable and efficient simulations. Position Based Dynamics (PBD) [42] updates positions directly to project constraints in a highly parallel fashion. eXtended Position Based Dynamics (XPBD) [39] overcome the limitation of iteration dependent behavior of PBD while Projective Dynamics [7] connects nodal Finite Element methods and Position Based methods, leading to an efficient and accurate solver. Stuyck [52] provides an overview on cloth simulation techniques.

Garment Pattern Estimation is important as the 2D sewing pattern influences the fit and the formation of wrinkles on the 3D body. One approach involves flattening the 3D shape into several developable [51]2D pieces. However, these methods require manual cutting input to generate pieces with minimal distortion [3, 43]. Other works use neural networks to learn the seams [18] but the patterns obtained through direct flattening of the 3D shape are only suitable for nearly undeformed cloth, which is rarely the case in real-world draped garments. Follow-up works employed neural networks to learn the 2D rest shape and yield more accurate patterns, but their generality is limited to the training data and specific garments [11, 65]. Parameterized garment patterns [25, 26] address these limitations and can adapt to a wide range of shapes but struggle to generalize to real garments and lack control over symmetry and matching seam lines. Alternatively, 2D patterns can be optimized using a physics simulator in an iterative manner [5, 56, 62].

Differentiable Simulation allows for gradient computation with respect to simulation parameters, enabling the use of gradient-based optimization algorithms to find solutions for inverse design and system identification. Early works used the adjoint method to fluid [31, 41] and cloth [61] simulation models to analytically compute gradients. Recent techniques differentiate through complex simulations such as Projective Dynamics [14] and XPBD [53]. Differentiable simulation methods have been applied to cloth simulation with frictional contact [32], material estimation [9, 27] and shape and pose estimation [21].

Learning-based approaches have focused on garment draping, modeling of cloth dynamics, or handling collisions and contact [6, 8, 19, 22, 24, 28, 30, 35, 46, 47, 49, 50, 55, 56, 64, 65] and hair [60, 61] and the introduction of new largescale datasets [68] albeit synthetic, will further accelerate this progress. DrapeNet [13] predicts a 3D deformation field conditioned on the latent codes of a generative network, which models garments as unsigned distance fields allowing it to handle and edit unseen clothes. Qiu et al. [45] reconstruct 3D clothes from monocular videos using SDFs and deformation fields. Qi et al. [44]proposed a personalized 2D pattern design method using synthetic data, where the user can input specific constraints for personal 2D pattern design from 3D point clouds. Li et al. [29]proposed a parametric garment representation model for garment draping using SDFs.

### 3. Preliminaries

### 3.1 Body and Garment Models

Body Shape and Pose may be represented using a parameterized statistical body model [37]. In some such models, the skeleton may be defined by joints which are described by P parameters encoding local transformations through joint angles ψ and bone lengths. The shape may be encoded by the statistical shape coefficients v as V₀+v^{V} where V₀ and V encode the average body shape and the shape basis functions respectively. The body shape with V_{b} vertices may be posed at every frame using a linear blend skinning function [symbol] : [symbol] ^{3×V}^{_{b}}× [symbol] ^{P}→ [symbol] ^{3×V}^{_{b}}[40].

Garments can take on a wide range of 3D shapes when draped onto a body, due to factors such as changing pose and dynamics, wearer manipulations, and more. Despite this large variation in configurations, garments are compactly represented by their 2D patterns, which consist of the individual pieces of fabric that are sewn together to create the 3D clothing. Therefore, some embodiments represent clothing in 2D pattern space, which ensures developable meshes and manufacturable clothing in the real world. Virtual garments are modeled as triangle meshes, with their rest shape encoded in these 2D patterns. The rest shape may be used for modeling the in-plane stretching and shearing behavior of different fabrics.

### 3.2 Cloth Simulation

Some embodiments compute the deformation of a garment mesh consisting of V vertices using physics-based simulation to solve Newton's equations of motion given by M\dot{v}=−∇U(x), where v∈ [symbol] ^{3v} are vertex velocities and X∈ [symbol] ^{3v} are vertex positions, with energy potential U(x) and mass matrix M. The simulator advances the garment state qₙ=(xₙ, vₙ) at time step n forward in time at discrete time steps Δt. The full set of simulated states Q=(qₙ)_{N} consists of states over all time steps N. The energy potential U(x) may be formulated in terms of a vector of all constraint functions C(x) and an inverse compliance matrix α⁻¹ as

$$U ( x ) = \frac{1}{2} {C ( x )}^{T} {a}^{- 1} C ( x ) .$$

Example constraint functions are those that model in-plane stretching and shearing, out-of-plane bending, and collisions, referred to as triangle constraints, dihedral bending constraints, and collision constraints respectively. At each time step, a position update Δx may be computed using a few Gauss-Seidel-like iterations indexed by i of the following system:

$$\begin{matrix}( ∇ {C ( {x}_{i} )}^{T} {M}^{- 1} ∇ C ( {x}_{i} ) + \tilde{α} ) Δλ = - C ( {x}_{i} ) - \tilde{α} {λ}_{i} \\ Δ x = {M}^{- 1} Δ C ( {x}_{i} ) Δλ\end{matrix} \qquad ( 1 )$$

where \tilde{α}=α/Δt². Due to the decoupled nature of the solve, the position update Δx can be computed separately for each constraint type as a sum of Δx_{Triangle}, Δx_{Dihedral}, Δx_{cloth-body collision} and Δx_{cloth_cloth collision} which may be then used to advance the vertex positions

$${x}_{n + 1} = {x}_{n} + Δ x + Δ t ( {v}_{n} + Δ {tM}^{- 1} {f}_{ext} ) \qquad ( 2 )$$

and velocities

$${v}_{n + 1} = \frac{1}{Δ t} ( {x}_{n + 1} - {x}_{n} )$$

where fₑₓₜ denote the external forces acting on the system.

### 3.3 Differentiable Cloth Simulation

Differentiable simulation enables the efficient computation of gradient information of parameters θ that impact the outcome of simulated quantities computed through complex dynamic simulations. DiffXPBD [53] may be used to compute gradients through the XPBD simulation model. In order to efficiently minimize a goal function φ which depends on simulated quantities using gradient-based methods, the full derivative dφ/dθ may be directly computed as:

$$\frac{d ϕ}{d θ} = \frac{\partial ϕ}{\partial Q} \frac{dQ}{d θ} + \frac{\partial ϕ}{\partial θ} \qquad ( 3 )$$

However, due to the intractability of computing dQ/dθ, one can resort to the adjoint method to convert this computation into a more efficient formulation by replacing the vector-matrix product with an equivalent computation involving the adjoint of Q, denoted by \hat{Q} which contains all adjoint states \hat{q}ₙ=(\hat{x}ₙ∈ [symbol] ^{3V}, \hat{v}ₙ∈ [symbol] ^{3V}) over all times N. Using the adjoint states, the full derivative dφ/dθ may be more easily obtained using

$$\frac{d ϕ}{d θ} = {\hat{Q}}^{T} \frac{\partial Δ x}{\partial θ} + \frac{\partial ϕ}{\partial θ} \qquad ( 4 )$$

where Δx refers to the position updates computed in the XPBD framework in Eq. 1. The adjoint states \hat{Q} may be a known and computable quantity. The remaining quantities to be computed are ∂Δx/∂θ and ∂φ/∂θ.

### 4. Methodology

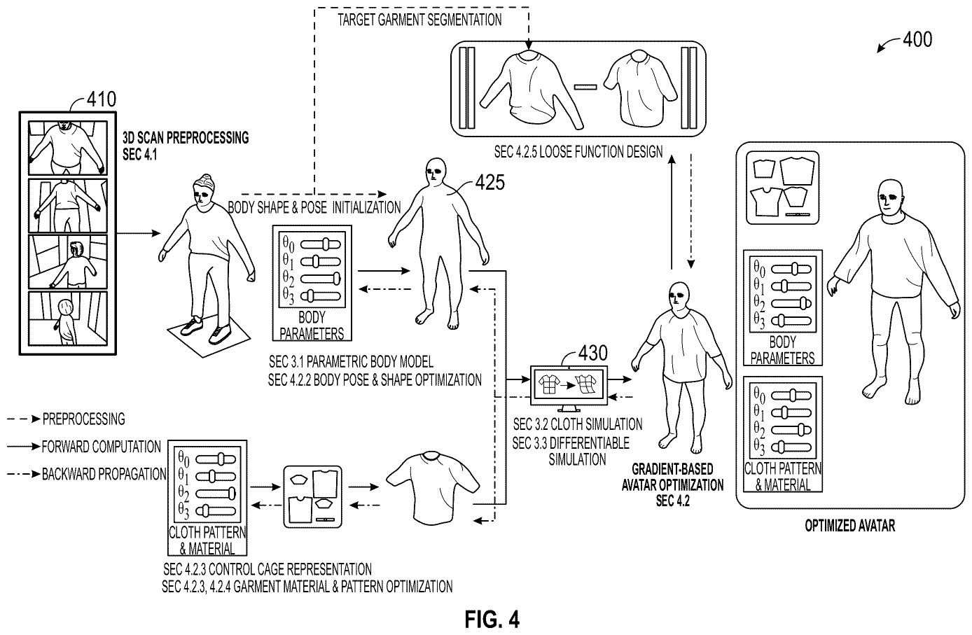

FIG. 4 illustrates a pipeline 400 to generate simulation-ready avatar assets from inputs obtained through a multi-view capture, according to some embodiments. The pipeline initially preprocesses a 3D scan 410 to segment the target garment and establish the initial pose and shape 425 of the parametric body model. The pipeline 400 employs a differentiable simulation framework 430 to align the simulated garment with the segmented garment by jointly optimizing the garment's design and material parameters, along with the body shape.

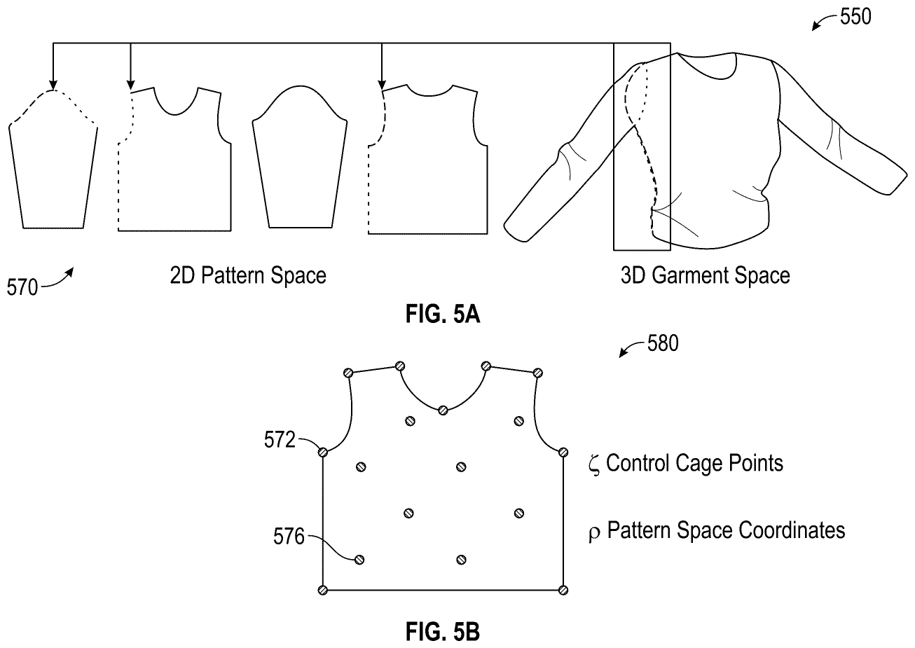

FIG. 5A illustrates seam length regularization, according to some embodiments. Three-dimensional (3D) garments 550 can be compactly represented as two-dimensional (2D) panels 570. Seams are visualized as dotted-lines, and color-coded to indicate seams that are to be sewn together should have the same length.

An example follows for a computational approach of some embodiments for extracting garment and body assets from real 3D scans of clothed humans. The example uses a differentiable simulator for simultaneous co-optimization of garment 2D pattern shape, cloth material, body pose and shape.

Starting from an automatically selected template, the goal of the computation may be to optimize garment patterns and materials that replicate the overall style and fit of the scan. Any garment can be draped on the body in various ways and may be adjusted by the wearer, therefore the goal is not to perfectly recreate the garment shapes as they appear in the scan, including wrinkles and surface details. Additionally, the overall body shape and pose are recovered, but other appearance aspects such as the face are not recovered, since it does not influence the simulated behavior of the clothing.

### 4.1 Extracting 3D Garments and Parametric Body

Some embodiments use a 3D Scan Semantic Garment Segmentation to process multi-view images, reconstruct and segment a 3D scan, and use this geometry to fit shape and pose of a parametric body model. From multi-view images of a clothed person, a 3D scan may be reconstructed using the 3dMD system [0137]. These scans tend to be noisy, contain holes and regions such as hair or loose clothes are hard to capture accurately. The 3D geometry of the isolated garment(s) of interest may be extracted by running a cloth segmentation algorithm [0152] on each of the 18 camera views, which provides per-pixel class predictions. The multi-view class consistency may be enforced by selecting the garment classes that appear in the majority of the views. Given this segmentation information, the garment of interest may be extracted from the mesh.

Body Shape and Pose Initialization: To fit the parametric body model to the scan, the body shape v, pose ψ and joint lengths are optimized by minimizing the Chamfer distance between the body vertices and those of the full person scan. A Gauss-Newton solver may be used that takes into account joint limits and penalizes self-collisions of the body mesh.

### 4.2 Avatar Optimization

Some embodiments utilize differentiable simulation (see Section [0062]) to recover body pose and shape, as well as garment shape and material, by adjusting these parameters to fit the processed scan data. Starting with an initial pattern, the size and shape of each panel in the pattern may be automatically adjusted. To achieve this, a minimal garment library may be used that defines the pattern structure for each type of garment. The semantic information obtained in Section [0071] may be used to automatically identify the garment types. With the estimated body shape and pose, the selected garment may be automatically draped to obtain the initial 3D configuration of clothing draped on the body, which enables physically-based cloth simulations.

### 4.2.1 Optimization Problem Statement

After initialization a complex optimization problem is solved, formulated as arg min_{θ}φ(θ, Q), to find the parameters θ that minimize a loss function φ(θ, Q). The loss function encodes how close the geometry is to the desired shape and is detailed in Section [0090]. For the purpose of avatar optimization, the control variables θ may be chosen to represent statistical body shape v and pose ψ coefficients to model the body shape under the clothing, material parameters λ to model the fabric properties and the pattern space coordinates p of the garment which are controlled by a cage deformer using the control points ζ which is introduced in Section [0082].

Some embodiments utilize gradient descent to optimize these quantities over multiple iterations. In each iteration, a differentiable simulation may be run with the current best estimate of parameters θ to obtain a draped garment. This draped garment may be then used to compute a loss, and the gradient information dφ/dθ may be obtained through a backward pass using the differentiable simulator. As shown in Eq. 4, once the adjoint states \hat{Q} are calculated, the full gradient may be determined by computing the missing terms ∂Δx/∂θ and ∂φ/∂θ and inserting them into the equation. The following subsections provide examples of how to find gradients with respect to these chosen parameters.

### 4.2.2. Body Shape and Pose Optimization

The geometry-based optimizer (Section [0071]) fits the unclothed body shape to the geometry of a scan of a clothed human. To improve the accuracy of the results, the body shape and pose may be refined by utilizing a differentiable simulation framework to fine-tune the estimates. This may be achieved by explicitly taking the cloth geometry as a separate layer on top of the body into account. The body geometry only affects the cloth dynamics through collision events between the body and clothing, therefore it is only needed to compute the derivatives for the collision response updates ∂Δx_{cloth-body collision} to evaluate Eq. 4. By applying the chain rule, this may be computed as follows:

$$\frac{\partial Δ {x}_{cloth - body collision}}{\partial a} = \frac{\partial Δ {x}_{cloth - body collision}}{\partial {x}_{body}} \frac{\partial {x}_{body}}{\partial a} \qquad ( 5 )$$

where α is either body shape v or pose ψ. The first term ∂Δx_{cloth-body collision}/∂x_{body} measures how the cloth position updates changes with a change in position update of the body vertices. For the body shape, the final term may be computed by differentiating through the body shape model described in Sec. [0055] which results in the shape basis functions v. Joint angle gradients may be obtained by differentiating through the linear blend skinning operation.

### 4.2.3. Garment Pattern Optimization

Some embodiments provide a regularized cage formulation that enables effective and robust optimization for the 2D patterns of garments such that the simulated and draped 3D representation of the garment closely aligns with the scan.

Differentiable Control Cage Formulation: FIG. 5B illustrates control cage vertex points 572 and pattern space coordinates 576 for a 2D panel 580, according to some embodiments. The location of the 2D control vertices ζ may be optimized on the boundaries of the individual panels of the 2D pattern. While it may be possible to directly optimize for the 2D coordinates p per vertex, which theoretically results in higher modeling capabilities, this approach is highly non-regularized and can produce ill-shaped or even non-physical inverted rest shape geometries that cause any simulator to fail (See ablation study Sec. Error! Reference source not found.). Additionally, directly optimizing for the 2D coordinates does not respect design constraints that are better represented in a limited subspace of reasonable designs. Therefore, the problem may be further regulated by optimizing a set of 2D control vertices ζ that directly deform and manipulate the underlying 2D patterns through control cages instead.

Control Cage Point/Handle Selection: The geometric information of the 2D garment patterns may be used to automatically identify control cage points. To do this, the boundary loop of the underlying mesh may be first extracted for each connected component representing a garment panel in the 2D garment pattern. The boundary loop may be processed and a vertex marked as a control point if it lies on the convex hull of the pattern or when its local curvature passes a threshold (10° in the example implementation).

Differentiable Control Cage Deformation: The control cage points set via Mean Value Coordinates [0159] are used to deform the underlying 2D pattern. During initialization, a general barycentric coordinate may be computed for each vertex in the 2D pattern with respect to each vertex on the control cage, expressed as p=Wζ. The required derivatives to evaluate Eq. 4 following the chain rule are computed as

$$\frac{\partial Δ x}{\partial ζ} = \frac{\partial Δ {x}_{triangle}}{\partial p} \frac{\partial p}{\partial ζ} = \frac{\partial Δ {x}_{triangle}}{\partial p} W \qquad ( 6 )$$

where the first term differentiates directly through the position update of the triangle constraints with respect to the rest shape coordinates of the triangle vertices in pattern space. The remaining term requires differentiating through the control cage formulation which results in ∂p/∂ζ=W.

### 4.2.4. Material Property Estimation

Some embodiments of the physically-based simulation pipeline allow to directly optimize for cloth material properties. This allows the method to better match the shape of the scanned clothing (especially loose fitting clothing). It is known [0151] that the bending parameter has the most significant effect on simulation results. Following this recommendation, optimizing may be for bending only, which can drastically change the look of loose fitting garments. Optimizing for the bending parameter X may require additional differentiating through the simulation update with respect to X in order to evaluate Eq 4. Since the bending material parameter is only used when computing dihedral constraint, this reduces to ∂Δx/∂λ=∂Δx_{Dihedral}/∂λ.

### 4.2.5. Loss Function Design

In some embodiments, the loss function may be designed with two main components: the feature matching term [symbol] _{features} and the regularization term [symbol] _{regularization}. The feature matching terms encourage the optimization to converge to the scan in the 3D world coordinates after simulations, while the regularization terms operate on the 2D patterns to maintain desired features. The loss function may be thus given by φ= [symbol] ^{features}+ [symbol] ^{regularization}.

Feature Matching may be used to ensure that the simulated garment matches the scan. Two distinct terms may be used with individual weights ρ and σ to achieve this goal. The boundary loss term measures how well the boundaries overlap and serves to drive correct lengths of the pattern to match size, whereas the interior loss may be designed to match the looseness of the fit: [symbol] _{features}+ρ [symbol] _{boundary}+σ [symbol] ᵢₙₜₑᵣᵢₒᵣ.

Boundary Feature Detection and Matching: Boundary points on the scan were segmented, and aligned and matched with those of the simulated garment, and minimized the L2 distance to boundaries such as sleeve lengths and hems.

Interior Point Feature Matching: Some embodiments measure and minimize the widely adopted Chamfer distance between the interior points of the simulated garment and target segmented garment scan.

Regularizers: To improve the loss formulation, some embodiments include additional regularization that act on the pattern space to maintain desired features in the design. The optimizer may be enabled to adapt individual patterns in the garment design to match features in the 3D scan. However, this process could result in designs where seams that are to be sewn together have different edge lengths, leading to undesired artifacts such as gathering, which produces a ruffled effect. To prevent this, two regularizers may be added with weights α and β, giving [symbol] _{regularization}=α [symbol] _{seam length}+β [symbol] _{curvature}. The technique penalizes seam length differences for edges on the individual patterns that are to be sewn together, as shown in FIG. 5B. Mathematically, this may be expressed as follows:

$${ℒ}_{seam length} = {\sum }_{i ∈ Seam edges} {‖ {P}_{i} - {P}_{i + 1} ‖}^{2} - {‖ {{P}^{′}}_{i} - {{P}^{′}}_{l + 1} ‖}^{2}$$

Additionally, to prevent noisy and undesired designs, the changes of the boundary curvature of the 2D patterns may be penalized with respect to the original garment template:

$${ℒ}_{curvature =} {\sum }_{i ∈ boundry} {𝒲}_{i} {‖ {t}_{i} - {T}_{i} {\overline{t}}_{i} ‖}^{2}$$

with tᵢ=pᵢ₊₁+pᵢ₋₁−2pᵢ, t̅ᵢ=p̅ᵢ₊₁+p̅ᵢ₋₁−2p̅ᵢ. The quantities denoted by ⋅̅ refer to the UV coordinates in the original garment pattern and Tᵢ=sRᵢ∈ [symbol] ^{2×2} is the scaled rotation matrix with least curvature distortion on each edge: arg minR∥eᵢ₁−Tᵢēᵢ₁∥²+∥eᵢ₂−Tᵢēᵢ₂∥² with eᵢ₁=pᵢ₊₁−pᵢ and eᵢ₂=pᵢ₋₁−p₁.

### 5. Experiments

Data: To evaluate the technique of some embodiments, a variety of 3D scans of humans were captured with a 3dMD [1] system. Four subjects were selected wearing different garments (dress, long-sleeve, polo, shirt) and their corresponding 3D reconstructions obtained. Note that these scans tend to be noisy and contain holes. Nevertheless, they still served as 3D targets during the optimization process. It is important to note that there are no perfect or clean “ground-truth” 3D scans available for evaluation. To address this, a skilled professional artist was also asked to create virtual garments that match the scans to the best of their ability. This process serves as an upper quality bar. Therefore, quantitative comparisons were provided using both the 3D scan input and the artist-made garments as ground-truth to demonstrate the clear improvements the technique of some embodiments offers over previous work.

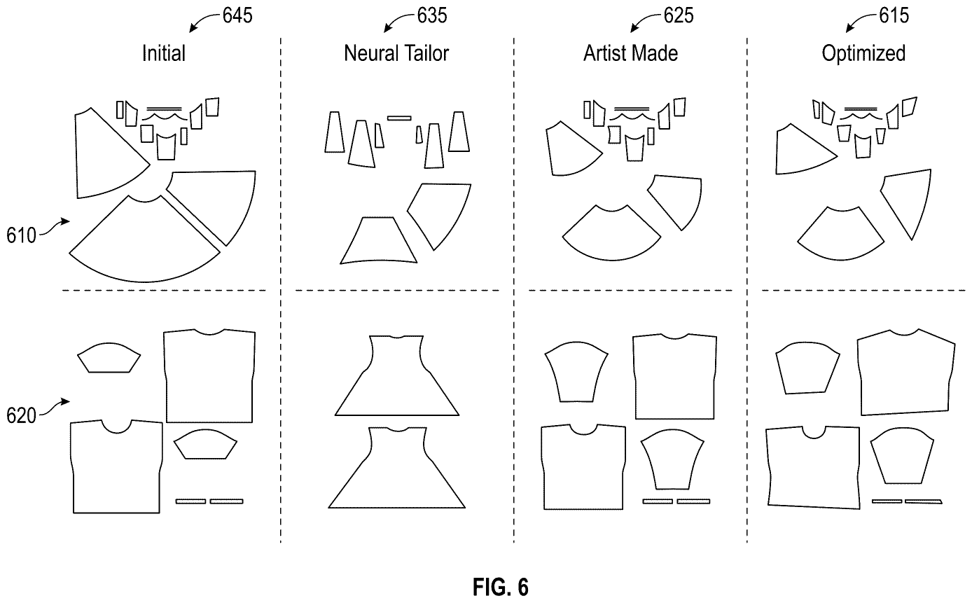

FIG. 6 illustrates a comparison of 2D patterns generated from some embodiments to artist-made patterns and those generated from previous solutions. The comparison includes optimized 2D patterns 605 of a dress 610 (first row) and long sleeve shirt 620 (second row) obtained with some embodiments against the artist made patterns 625 and other patterns 635 generated by NeuralTailor. Starting from the initial patterns 645 in the first column, the output of some embodiments generates optimized 2D patterns 605 closely resembling the artist made patterns 625 (second last column). In contrast, although NeuralTailor (second column) does not need an initial template, the other patterns 635 can be far from the target and can even be missing key features like the sleeves on the shirt in the bottom row.

Baselines: The output geometry of some embodiments was evaluated against prior art methods that employ 2D images as an input and one that uses 3D scans. Specifically, PiFUHD [0184] was run on the clothed human scan and the garment segmented in 3D to use it for evaluations. Wonder3D [0172] was also used, a recent diffusion-based approach that given a single garment image, synthesizes six multi-view consistent novel views, and then used NeuS [0193] to extract the 3D geometry. The comparison was also made against PoP [0174] which uses 3D scans as an input and outputs a point cloud of the clothed human that is passed to Poisson reconstruction to obtain the mesh. Finally, a comparison of the 2D patterns is performed against NeuralTailor [0161] which estimates 2D garment patterns from 3D point clouds of a draped garment.

Evaluation Metrics: The Chamfer Distance (CD) was used for comparisons directly in 3D, and LPIPS [0202] and SSIM [0194] for perceptual metrics in the 2D space using the exact same rendering conditions for all methods. The metrics are reported in Table 1.

Implementation Details: The technique was implemented in C++ using open source libraries like Eigen and libigl. All experiments were run on a machine with 14-core i7 CPU with 32 GB RAM.

Performance: In the example given, the technique incorporates simulation within an optimization process to yield high-quality outcomes at the expense of increased computational requirements. Optimization takes about one minute per iteration and total times vary between 20 to 200 minutes depending on the garment and iteration count. Baseline methods range between several seconds to 10 minutes for complete inference results. Note that the technique can be executed in batch mode automatically. The technique runs on CPU, whereas the baselines are run on an NVIDIA GeForce RTX 4080 GPU.

### 5.1 Garment Pattern Optimization

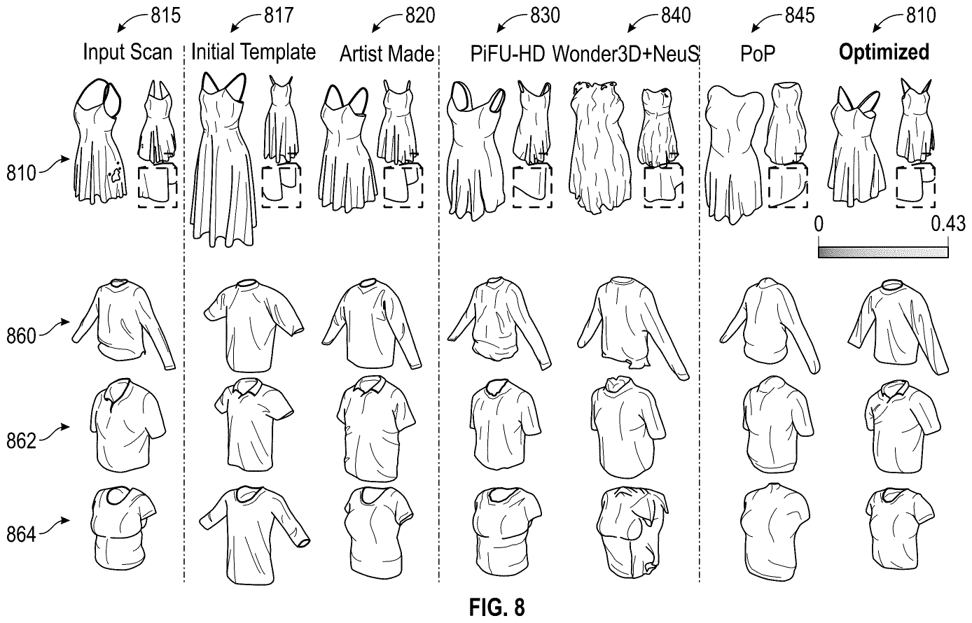

FIG. 8, which is described below, shows results of the 3D optimized shapes. The corresponding 2D optimized patterns for the dress and long sleeve shirt are shown in FIG. 6. Starting from the initial panel in the first column, the technique of some embodiments (last column) generates patterns closely resembling the one designed manually by an artist (second last column). In contrast, although NeuralTailor [25](second column) does not need an initial template, the result can be far from the target and can even be missing key features like the shirt sleeves.

Accordingly, it is shown that the automated technique of some embodiments may be able to closely match manually created patterns by an experienced artist through a time-consuming process.

### 5.2 Body and Cloth Material Optimization

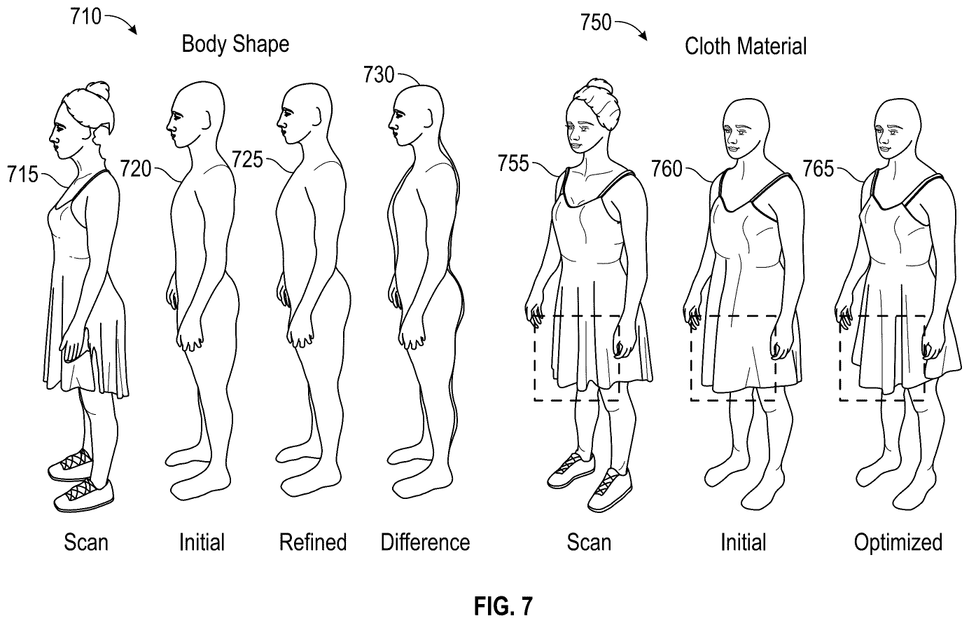

FIG. 7 illustrates body shape and cloth material estimation, according to some embodiments. Different stages 710 of body shape estimation are shown on the left. A statistical body model was fit to the 3D scan 715, resulting in an initial estimate 720 of body shape. The differentiable simulation pipeline (see FIG. 4) was used to refine the initial estimate 720, resulting in a refined estimate 725. The difference 730 is shown between the initial estimate 720 and the final refined estimate 725. Recovery of cloth material properties 750 to match the drape of the garment in the scan are shown on the right. From the 3D scan 755, the initial material estimate 760 produces large folds that do not match the 3D scan 755 as well as the optimized result 765 shown rightmost.

### 5.3. Method Evaluations

FIG. 8 illustrates qualitative comparisons between the optimized output 810 of some embodiments and other techniques. The optimized output 810 of some embodiments captures garments with natural draping behavior and wrinkle details where all prior works fail to reconstruct simulation-ready meshes. The top row includes a comparison of mesh quality of the optimized output 810 versus the input scan 815, the initial template 817, and artist-made meshes 820, visualized with a gradient with white representing highest quality. The technique of some embodiments generates simulation-ready meshes of high quality, comparable to artist-made meshes 820 where 2D prior works such as PiFU-HD [48] 830 andWonder3D+NeuS [36,58] 840, or 3D works such as PoP [38] 845 come short. The bottom rows 860, 862, 864 show additional output examples of other types of clothing.

TABLE 1

| | | | | | | | Mesh |
|---|---|---|---|---|---|---|---|
| | Against GT Scan | | | Against GT Artist | | | Quality↑ |
| Method | CD↓ | LPIPS↓ | SSIM↑ | CD↓ | LPIPS↓ | SSIM↑ | min(avg) |
| Scan | — | — | — | 1.045 | 0.127 | 0.852 | 0.099(0.422) |
| Artist | 1.045 | 0.127 | 0.852 | — | — | — | 0.171(0.389) |
| Initial | 3.071 | 0.165 | 0.815 | 3.396 | 0.123 | 0.859 | 0.188(0.391) |
| PiFU-HD | 1.930 | 0.145 | 0.836 | 2.009 | 0.129 | 0.836 | 0.000(0.305) |
| Wonder3D + NeuS | 3.410 | 0.171 | 0.799 | 3.362 | 0.177 | 0.797 | 0.000(0.266) |
| PoP | 1.695 | 0.140 | 0.831 | 1.866 | 0.092 | 0.842 | 0.000(0.316) |
| Optimized | 1.311 | 0.133 | 0.842 | 1.688 | 0.085 | 0.893 | 0.143(0.373) |

Table 1 illustrates quantitative comparisons. The 3D scan and artist-made mesh were used as ground truth (GT) to evaluate the technique of some embodiments on the dress example. The results show that the 3D optimized output has the closest CD fit, best perceptual metrics, and produced good mesh quality. In contrast, all competing methods produce a minimum mesh quality of 0 (or near 0), making their output unsuitable for simulation.

The reconstructed 3D geometry of some embodiments was evaluated against prior works (see FIG. 8) and quantitative results summarized in Table 1. Regardless of the ground-truth considered (scan or artist-made), the technique of some embodiments outperformed all prior works across both 2D and 3D metrics. PiFUHD [48] and Wonder3D+NeuS reconstruct the frontal part of the geometry, but the back side is smooth and all results lack fine-level details (wrinkles and folds). PoP fails to accurately reconstruct the details of a dress, producing closed-surface meshes without arm holes that are unsuitable for simulation. It is evident from these results that the approach of some embodiments is the only one capable of capturing the garment with simulation-ready topology. To evaluate mesh quality, a conditioning quality metric [51] was applied to the 3D meshes for a fair comparison with the baseline methods that do not produce rest shape geometry. Prior methods produce a near 0 minimum mesh quality, which indicates the presence of poorly-conditioned or zero-area triangles that are unsuitable for simulation. The results show favorable quality compared to all past works.

### 5.4. Ablation Studies

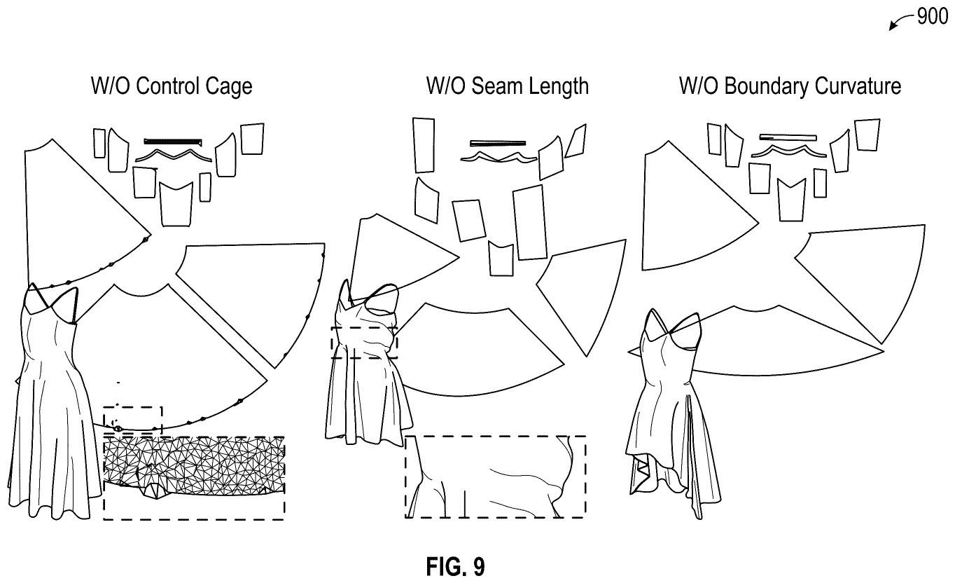

An ablation study was performed on the importance of individual components in the loss function design. By removing each of the proposed components of the technique of some embodiments, the impact of each component is demonstrated in 3D with Chamfer Distance and 2D with perceptual metrics to the final result for the dress against the ground-truth scan. Visual results are shown in FIG. 9, and Table 2 provides quantitative measures. The results demonstrate that the control cage formulation is important for producing physically correct results. The seam length regularizer may be necessary to prevent seam length mismatches, which leads to excessive gathering of the fabric. Additionally, the boundary curvature regularizer may be required to preserve the design intent of the garment.

FIG. 9 illustrates the results 900 of an ablation study, according to some embodiments. Left: without a control cage, the optimizer produces inverted non-physical triangle elements (high-lighted) in the rest shape which causes the simulator to fail. Middle: without seam length regularization, the seam lines do not match leading to excessive amount of fabric. Right: without boundary curvature regularization, the pattern distorts into unwanted shapes.

TABLE 2

| Method Variant | CD↓ | LPIPS↓ | SSIM↑ |
|---|---|---|---|
| w/o Control Cage | 3.866 | 0.168 | 0.792 |
| w/o Seam Length | 1.409 | 0.115 | 0.843 |
| Term | | | |
| w/o Boundary | 2.249 | 0.124 | 0.838 |
| Curvature Term | | | |
| Optimized | 1.122 | 0.102 | 0.863 |

### 5.5 Novel Simulated Sequences

In contrast to baseline methods, the technique of some embodiments generates high-quality simulation-ready geometry with associated 2D rest shape and cloth material properties, enabling creation of new simulations that are faithful to the original garment. FIG. 3 shows select frames from novel simulated sequences using the optimized dress.

### 5.6 Limitations and Future Work

The technique of some embodiments relies on a provided 2D pattern for each garment category to achieve an accurate fit. This may be done by optimizing through a continuum of pattern variations. Although discrete changes in the number of pattern pieces or mesh topology are not addressed, such a system can be incorporated into the pipeline retroactively. Although the technique uses a dynamic differentiable simulator, it currently only relies on states close to quasi-equilibrium to estimate static scans. This implies that draped garments with strong friction or dynamic effects can be challenging to estimate and can produce a different final aesthetic. For instance, the horizontal folds due to friction in the second row of FIG. 8 or a loose dress captured mid motion cannot be easily reproduced without considering the simulation trajectory. While this may seem like a limitation, the choice of starting with a dynamic simulator affords an extension to improve estimates by matching to dynamic sequences and recover additional parameters. In the case of multi-layered clothing, much of the useful data about garments involved can be occluded, making it an especially difficult target for methods relying too heavily on visual feedback. The technique of some embodiments may be well suited to handle occlusions because it has strong built-in physical priors about the behavior of unseen fabric to guide the estimation process. To eliminate the need for a capture system, in some embodiments, it may be more effective to start from image data directly and recover scans using techniques like PiFUHD [0184] to generate simulation-ready avatars from single images only.

### CONCLUSION

Some embodiments introduce a new approach that utilizes differentiable simulation for scene recovery to generate high-quality, physically plausible assets. The technique considers the complex non-linear behavior of cloth and its intricate interaction with the underlying body, optimizing for scene parameters in a unified and coupled manner that takes into account the interplay of all components.

The technique of some embodiments outperforms prior works across different metrics, producing high-quality garment results in both 3D and the 2D pattern space and generates simulation-ready assets close to those that are manually designed by a trained artist.

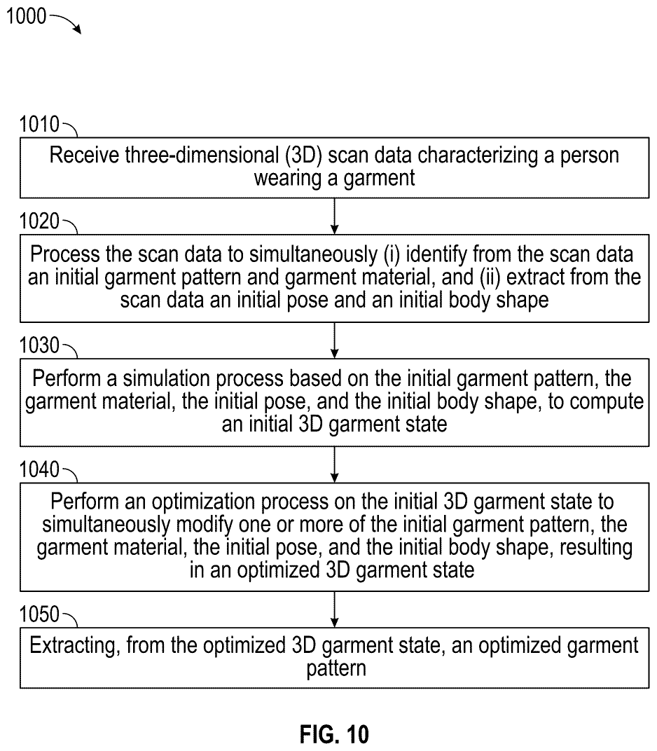

FIG. 10 is a flowchart illustrating a process 1000 for extracting clothing assets performed by a client device (e.g., client device 110-1, etc.) and/or a client server (e.g., server 130-1, etc.), according to some embodiments. In some embodiments, one or more operations in process 1000 may be performed by a processor circuit (e.g., processors 205, etc.) executing instructions stored in a memory circuit (e.g., memories 220, etc.) of a system (e.g., system 200, etc.) as disclosed herein. For example, operations in process 1000 may be performed by asset extraction application 222, asset extraction engine 242, or some combination thereof. Moreover, in some embodiments, a process consistent with this disclosure may include at least operations in process 1000 performed in a different order, simultaneously, quasi-simultaneously, or overlapping in time.

At 1010, the process 1000 receives three-dimensional (3D) scan data characterizing a person wearing a garment.

In some embodiments, the scan data includes a 3D mesh, and processing the scan data includes performing a segmentation process on the 3D mesh to identify the garment. In some embodiments, identifying the initial garment pattern and the garment material includes selecting a particular garment template from a group of garment templates based on identification of the garment.

In some embodiments, the scan data includes multiple views of the person from multiple different viewpoints.

At 1020, the process 1000 processes the scan data to simultaneously (i) identify from the scan data an initial garment pattern and garment material, and (ii) extract from the scan data an initial pose and an initial body shape.

In some embodiments, processing the scan data includes fitting a parametric body model to the scan data.

In some embodiments, the initial garment pattern includes multiple two-dimensional (2D) panels joined by seams, and the optimization process modifies the 2D panels. For example, each 2D panel may include multiple control handles on one or more boundaries of the 2D panel, and multiple vertices each having coordinates with respect to the control handles. The optimization process may modify the coordinates of the control handles to deform the 2D panel. In some embodiments, the optimization process uses a loss function that includes a regularization term to match lengths of the seams between the 2D panels and to constrain a curvature of the one or more boundaries of each 2D panel.

At 1030, the process 1000 performs a simulation process based on the initial garment pattern, the garment material, the initial pose, and the initial body shape, to compute an initial 3D garment state.

At 1040, the process 1000 performs an optimization process on the initial 3D garment state to simultaneously modify one or more of the initial garment pattern, the garment material, the initial pose, and the initial body shape, resulting in an optimized 3D garment state. In some embodiments, the optimization process uses differentiable simulation.

In some embodiments, the optimization process estimates the garment material by optimizing for cloth bending properties.

At 1050, the process 1000 extracts, from the optimized 3D garment state, an optimized garment pattern. In some embodiments, the optimization process uses a loss function that includes a feature matching term to match the optimized garment pattern to the scan data.

In some embodiments, the optimized garment pattern may be used to manufacture a physical garment.

### REFERENCES

[1]3dmd applications. from healthcare to artificial intelligence. https://3dmd.com/. Accessed on November 2023.
[2] Dragomir Anguelov, Praveen Srinivasan, Daphne Koller, Sebastian Thrun, Jim Rodgers, and James Davis. SCAPE: Shape Completion and Animation of People. Association for Computing Machinery, New York, NY, USA, 1 edition, 2023.
[3] Seungbae Bang, Maria Korosteleva, and Sung-Hee Lee. Estimating garment patterns from static scan data. Computer Graphics Forum, 40(6):273-287, 2021.
[4] David Baraff and Andrew Witkin. Large steps in cloth simulation. In Proceedings of the 25th annual conference on Computer graphics and interactive techniques, pages 43-54, 1998.
[5] Aric Bartle, Alla Sheffer, Vladimir G. Kim, Danny M. Kaufman, Nicholas Vining, and Floraine Berthouzoz. Physics-driven pattern adjustment for direct 3d garment editing. ACM Trans. Graph., 35(4), jul 2016.
[6] Hugo Bertiche, Meysam Madadi, and Sergio Escalera. Neural cloth simulation. ACM Transactions on Graphics (TOG), 41(6):1-14, 2022.
[7] Sofien Bouaziz, Sebastian Martin, Tiantian Liu, Ladislav Ka-van, and Mark Pauly. Projective dynamics: Fusing constraint projections for fast simulation. ACM transactions on graphics (TOG), 33(4):1-11, 2014.
[8] Andrés Casado-Elvira, Marc Comino Trinidad, and Dan Casas. Pergamo: Personalized 3d garments from monocular video. In Computer Graphics Forum, volume 41, pages 293-304. Wiley Online Library, 2022.
[9] Hsiao-yu Chen, Edith Tretschk, Tuur Stuyck, Petr Kadlecek, Ladislav Kavan, Etienne Vouga, and Christoph Lassner. Virtual elastic objects. In Proceedings of the IEEE/CVF Conference on Computer Vision and Pattern Recognition, pages 15827-15837, 2022.
[10] Xin Chen, Anqi Pang, Wei Yang, Peihao Wang, Lan Xu, and Jingyi Yu. Tightcap: 3d human shape capture with clothing tightness field. ACM Transactions on Graphics (TOG), 41(1):1-17, 2021.
[11] Xipeng Chen, Guangrun Wang, Dizhong Zhu, Xiaodan Liang, Philip H. S. Torr, and Liang Lin. Structure-preserving 3d garment modeling with neural sewing machines. In NeurIPS, 2022.
[12] Kwang-Jin Choi and Hyeong-Seok Ko. Stable but responsive cloth. In ACM SIGGRAPH 2005 Courses, pages 1-es. 2005.
[13] Luca De Luigi, Ren Li, Benoit Guillard, Mathieu Salzmann, and Pascal Fua. DrapeNet: Garment Generation and Self-Supervised Draping. In Proceedings of the IEEE/CVF Conference on Computer Vision and Pattern Recognition, 2023.
[14] Tao Du, Kui Wu, Pingchuan Ma, Sebastien Wah, Andrew Spielberg, Daniela Rus, and Wojciech Matusik. Diffpd: Differentiable projective dynamics. ACM Transactions on Graphics (TOG), 41(2):1-21, 2021.
[15] Xudong Feng, Wenchao Huang, Weiwei Xu, and Huamin Wang. Learning-based bending stiffness parameter estimation by a drape tester. ACM Trans. Graph., 41(6), nov 2022.
[16] Cheng-Yang Fu, Tamara L Berg, and Alexander C Berg. Imp: Instance mask projection for high accuracy semantic segmentation of things. In ICCV, 2019.
[17] Yotam Gingold, Adrian Secord, Jefferson Y Han, Eitan Grin-spun, and Denis Zorin. A discrete model for inelastic deformation of thin shells. In ACM SIGGRAPH/Eurographics symposium on computer animation. Citeseer, 2004.
[18] Chihiro Goto and Nobuyuki Umetani. Data-driven garment pattern estimation from 3d geometries. In Eurographics, 2021.
[19] Artur Grigorev, Michael J Black, and Otmar Hilliges. Hood: Hierarchical graphs for generalized modelling of clothing dynamics. In CVPR, 2023.
[20] Eitan Grinspun, Anil N Hirani, Mathieu Desbrun, and Peter Schroder. Discrete shells. In Proceedings of the 2003 ACM SIGGRAPH/Eurographics symposium on Computer animation, pages 62-67. Citeseer, 2003.
[21] Jingfan Guo, Jie Li, Rahul Narain, and Hyun Soo Park. Inverse simulation: Reconstructing dynamic geometry of clothed humans via optimal control. In Proceedings of the IEEE/CVF Conference on Computer Vision and Pattern Recognition, pages 14698-14707, 2021.
[22] Oshri Halimi, Tuur Stuyck, Donglai Xiang, Timur Bagautdi-nov, He Wen, Ron Kimmel, Takaaki Shiratori, Chenglei Wu, Yaser Sheikh, and Fabian Prada. Pattern-based cloth registration and sparse-view animation. ACM Transactions on Graphics (TOG), 41(6):1-17, 2022.
[23] Tao Ju, Scott Schaefer, and Joe Warren. Mean value coordinates for closed triangular meshes. ACM Transactions on Graphics, 24(3):561-566, 2005.
[24] Navami Kairanda, Marc Habermann, Christian Theobalt, and Vladislav Golyanik. Neuralclothsim: Neural deformation fields meet the kirchhoff-love thin shell theory. arXiv preprint arXiv:2308.12970, 2023.
[25] Maria Korosteleva and Sung-Hee Lee. Neuraltailor: Reconstructing sewing pattern structures from 3d point clouds of garments. 41(4), jul 2022.
[26] Maria Korosteleva and Olga Sorkine-Hornung. Garment-Code: Programming parametric sewing patterns. ACM Transaction on Graphics, 42(6), 2023. SIGGRAPH ASIA.
[27] Egor Larionov, Marie-Lena Eckert, Katja Wolff, and Tuur Stuyck. Estimating cloth elasticity parameters using position-based simulation of compliant constrained dynamics. arXiv preprint arXiv:2212.08790, 2022.
[28] Dohae Lee and In-Kwon Lee. Multi-layered unseen garments draping network. arXiv preprint arXiv:2304.03492, 2023.
[29] Ren Li, Benoi\hat{ }t Guillard, and Pascal Fua. Isp: Multi-layered garment draping with implicit sewing patterns. In NeurIPS, 2023.
[30] Ren Li, Benoi\hat{ }t Guillard, Edoardo Remelli, and Pascal Fua. Dig: Draping implicit garment over the human body. In ACCV, 2022.
[31] Yifei Li, Tao Du, Sangeetha Grama Srinivasan, Kui Wu, Bo Zhu, Eftychios Sifakis, and Wojciech Matusik. Fluidic topology optimization with an anisotropic mixture model. ACM Trans. Graph., nov 2022.
[32] Yifei Li, Tao Du, Kui Wu, Jie Xu, and Wojciech Matusik. Diffcloth: Differentiable cloth simulation with dry frictional contact. ACM Transactions on Graphics (TOG), 42(1):1-20, 2022.
[33] Yue Li, Marc Habermann, Bernhard Thomaszewski, Stelian Coros, Thabo Beeler, and Christian Theobalt. Deep physics-aware inference of cloth deformation for monocular human performance capture. In 2021 International Conference on 3D Vision (3DV), pages 373-384, Los Alamitos, CA, USA, dec 2021. IEEE Computer Society.
[34] Junbang Liang and Ming Lin. Fabric material recovery from video using multi-scale geometric auto-encoder. In European Conference on Computer Vision, pages 695-714. Springer, 2022.
[35] Lijuan Liu, Xiangyu Xu, Zhijie Lin, Jiabin Liang, and Shuicheng Yan. Towards garment sewing pattern reconstruction from a single image. ACM Transactions on Graphics (SIGGRAPHAsia), 2023.
[36] Xiaoxiao Long, Yuan-Chen Guo, Cheng Lin, Yuan Liu, Zhiyang Dou, Lingjie Liu, Yuexin Ma, Song-Hai Zhang, Marc Habermann, Christian Theobalt, and Wenping Wang. Wonder3d: Single image to 3d using cross-domain diffusion, 2023.
[37] Matthew Loper, Naureen Mahmood, Javier Romero, Gerard Pons-Moll, and Michael J. Black. SMPL: A skinned multi-person linear model. ACM Trans. Graphics (Proc. SIGGRAPH Asia), 34(6):248:1-248:16, Oct. 2015.
[38] Qianli Ma, Jinlong Yang, Siyu Tang, and Michael J Black. The power of points for modeling humans in clothing. In Proceedings of the IEEE/CVF International Conference on Computer Vision, pages 10974-10984, 2021.
[39] Miles Macklin, Matthias Mu″ller, and Nuttapong Chentanez. Xpbd: position-based simulation of compliant constrained dynamics. In Proceedings of the 9th International Conference on Motion in Games, pages 49-54, 2016.
[40] Thalmann Magnenat, Richard Laperriere, and Daniel Thalmann. Joint-dependent local deformations for hand animation and object grasping. Technical report, Canadian Inf. Process. Soc, 1988.
[41] Antoine McNamara, Adrien Treuille, Zoran Popovic′, and Jos Stam. Fluid control using the adjoint method. ACM Transactions On Graphics (TOG), 23(3):449-456, 2004.
[42] Matthias Mu″ller, Bruno Heidelberger, Marcus Hennix, and John Ratcliff. Position based dynamics. Journal of Visual Communication and Image Representation, 18(2):109-118, 2007.
[43] Nico Pietroni, Corentin Dumery, Raphael Falque, Mark Liu, Teresa Vidal-Calleja, and Olga Sorkine-Hornung. Computational pattern making from 3d garment models. ACM Trans. Graph., 41(4), jul 2022.
[44] Anran Qi, Sauradip Nag, Xiatian Zhu, and Ariel Shamir. Per-sonaltailor: Personalizing 2d pattern design from 3d garment point clouds. arXiv preprint arXiv:2303.09695, 2023.
[45] Lingteng Qiu, Guanying Chen, Jiapeng Zhou, Mutian Xu, Junle Wang, and Xiaoguang Han. Rec-mv: Reconstructing 3d dynamic cloth from monocular videos. In Proceedings of the IEEE/CVF Conference on Computer Vision and Pattern Recognition, pages 4637-4646, 2023.
[46] Carlos Rodriguez-Pardo, Melania Prieto-Martin, Dan Casas, and Elena Garces. How will it drape like?capturing fabric mechanics from depth images. In Computer Graphics Forum, volume 42, pages 149-160. Wiley Online Library, 2023.
[47] Cristian Romero, Dan Casas, Maurizio M Chiaramonte, and Miguel A Otaduy. Contact-centric deformation learning. ACM Transactions on Graphics (TOG), 41(4):1-11, 2022.
[48] Shunsuke Saito, Tomas Simon, Jason Saragih, and Hanbyul Joo. Pifuhd: Multi-level pixel-aligned implicit function for high-resolution 3d human digitization. In Proceedings of the IEEE/CVF Conference on Computer Vision and Pattern Recognition, pages 84-93, 2020.
[49] Igor Santesteban, Miguel A Otaduy, and Dan Casas. Snug: Self-supervised neural dynamic garments. In CVPR, 2022.
[50] Igor Santesteban, Nils Thuerey, Miguel A Otaduy, and Dan Casas. Self-supervised collision handling via generative 3d garment models for virtual try-on. In CVPR, 2021.
[51] Oded Stein, Eitan Grinspun, and Keenan Crane. Developa-bility of triangle meshes. ACM Transactions on Graphics (TOG), 37(4):1-14, 2018.
[52] Tuur Stuyck. Cloth simulation for computer graphics. Springer Nature, 2022.
[53] Tuur Stuyck and Hsiao-yu Chen. Diffxpbd: Differentiable position-based simulation of compliant constraint dynamics. Proceedings of the ACM on Computer Graphics and Interactive Techniques, 6(3):1-14, 2023.
[54] Zhaoqi Su, Liangxiao Hu, Siyou Lin, Hongwen Zhang, Shengping Zhang, Justus Thies, and Yebin Liu. Caphy: Capturing physical properties for animatable human avatars. In Proceedings of the IEEE/CVF International Conference on Computer Vision, pages 14150-14160, 2023.
[55] Garvita Tiwari, Nikolaos Sarafianos, Tony Tung, and Gerard Pons-Moll. Neural-gif: Neural generalized implicit functions for animating people in clothing. In ICCV, 2021.
[56] Huamin Wang. Rule-free sewing pattern adjustment with precision and efficiency. 37(4), jul 2018.
[57] Peng Wang, Lingjie Liu, Yuan Liu, Christian Theobalt, Taku Komura, and Wenping Wang. Neus: Learning neural implicit surfaces by volume rendering for multi-view reconstruction. arXiv preprint arXiv:2106.10689, 2021.
[58] Zhou Wang, Alan C Bovik, Hamid R Sheikh, and Eero P Si-moncelli. Image quality assessment: from error visibility to structural similarity. IEEE transactions on image processing, 13(4):600-612, 2004.
[59] Ziyan Wang, Giljoo Nam, Tuur Stuyck, Stephen Lombardi, Chen Cao, Jason Saragih, Michael Zollhöfer, Jessica Hod-gins, and Christoph Lassner. Neuwigs: A neural dynamic model for volumetric hair capture and animation. In Proceedings of the IEEE/CVF Conference on Computer Vision and Pattern Recognition (CVPR), pages 8641-8651, June 2023.
[60] Ziyan Wang, Giljoo Nam, Tuur Stuyck, Stephen Lombardi, Michael Zollhöfer, Jessica Hodgins, and Christoph Lassner. Hvh: Learning a hybrid neural volumetric representation for dynamic hair performance capture. In Proceedings of the IEEE/CVF Conference on Computer Vision and Pattern Recognition, pages 6143-6154, 2022.
[61] Chris Wojtan, Peter J Mucha, and Greg Turk. Keyframe control of complex particle systems using the adjoint method. In Proceedings of the 2006 ACM SIGGRAPH/Eurographics symposium on Computer animation, pages 15-23, 2006.
[62] Katja Wolff, Philipp Herholz, Verena Ziegler, Frauke Link, Nico Briigel, and Olga Sorkine-Hornung. Designing personalized garments with body movement. Computer Graphics Forum, 42(1):180-194, 2023.
[63] Donglai Xiang, Timur Bagautdinov, Tuur Stuyck, Fabian Prada, Javier Romero, Weipeng Xu, Shunsuke Saito, Jing-fan Guo, Breannan Smith, Takaaki Shiratori, et al. Dressing avatars: Deep photorealistic appearance for physically simulated clothing. ACM Transactions on Graphics (TOG), 41(6):1-15, 2022.
[64] Yuxuan Xue, Bharat Lal Bhatnagar, Riccardo Marin, Niko-laos Sarafianos, Yuanlu Xu, Gerard Pons-Moll, and Tony Tung. Nsf: Neural surface fields for human modeling from monocular depth. In ICCV, 2023.
[65] Shan Yang, Zherong Pan, Tanya Amert, Ke Wang, Licheng Yu, Tamara Berg, and Ming C. Lin. Physics-inspired garment recovery from a single-view image. ACM Trans. Graph., 37(5), nov 2018.
[66] Richard Zhang, Phillip Isola, Alexei A Efros, Eli Shechtman, and Oliver Wang. The unreasonable effectiveness of deep features as a perceptual metric. In CVPR, 2018.
[67] Xingxing Zou, Xintong Han, and Waikeung Wong. Cloth4d: A dataset for clothed human reconstruction. In Proceedings of the IEEE/CVF Conference on Computer Vision and Pattern Recognition, pages 12847-12857, 2023.

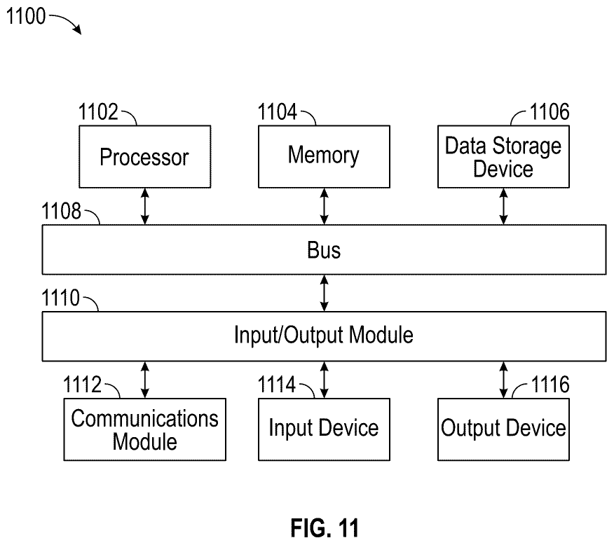

FIG. 11 is a block diagram illustrating an exemplary computer system 1100 with which aspects of the subject technology can be implemented. In certain aspects, the computer system 1100 may be implemented using hardware or a combination of software and hardware, either in a dedicated server, integrated into another entity, or distributed across multiple entities. As a non-limiting example, the computer system 1100 may be one or more of the servers 130 and/or the client devices 110.

Computer system 1100 includes a bus 1108 or other communication mechanism for communicating information, and a processor 1102 coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, i.e., one or more modules of computer program instructions encoded on a computer-readable medium for execution by, or to control the operation of, the computer system 1100, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage device 1106 such as a magnetic disk or optical disk, coupled to bus 1108 for storing information and instructions. Computer system 1100 may be coupled via input/output module 1110 to various devices. The input/output module 1110 can be any input/output module. Exemplary input/output modules 1110 include data ports such as USB ports. The input/output module 1110 is configured to connect to a communications module 1112. Exemplary communications modules 1112 include networking interface cards, such as Ethernet cards and modems. In certain aspects, the input/output module 1110 is configured to connect to a plurality of devices, such as an input device 1114 and/or an output device 1116. Exemplary input devices 1114 include a keyboard and a pointing device, e.g., a mouse or a trackball, by which a user can provide input to the computer system 1100. Other kinds of input devices 1114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1116 include display devices such as an LCD (liquid crystal display) monitor, for displaying information to the user.

According to one aspect of the present disclosure, the above-described embodiments can be implemented using a computer system 1100 in response to processor 1102 executing one or more sequences of one or more instructions contained in memory 1104. Such instructions may be read into memory 1104 from another machine-readable medium, such as data storage device 1106. Execution of the sequences of instructions contained in the main memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example, and without limitation, a desktop computer, laptop computer, or tablet computer. Computer system 1100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage device 1106. Volatile media include dynamic memory, such as memory 1104. Transmission media include coaxial cables, copper wire, and fiber optics, including the wires that comprise bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1100 reads application data and provides an application, information may be read from the application data and stored in a memory device, such as the memory 1104. Additionally, data from the memory 1104 servers accessed via a network, the bus 1108, or the data storage 1106 may be read and loaded into the memory 1104. Although data is described as being found in the memory 1104, it will be understood that data does not have to be stored in the memory 1104 and may be stored in other memory accessible to the processor 1102 or distributed among several media, such as the data storage 1106.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for extracting clothing assets, comprising:
receiving three-dimensional (3D) scan data characterizing a person wearing a garment;
processing the scan data to simultaneously (i) identify from the scan data an initial garment pattern and garment material, and (ii) extract from the scan data an initial pose and an initial body shape;
performing a simulation process based on the initial garment pattern, the garment material, the initial pose, and the initial body shape, to compute an initial 3D garment state;
performing an optimization process on the initial 3D garment state to simultaneously modify one or more of the initial garment pattern, the garment material, the initial pose, and the initial body shape, resulting in an optimized 3D garment state; and
extracting, from the optimized 3D garment state, an optimized garment pattern.

2. The method of claim 1, wherein the scan data comprises a 3D mesh, and processing the scan data comprises performing a segmentation process on the 3D mesh to identify the garment.

3. The method of claim 2, wherein identifying the initial garment pattern and the garment material comprises selecting a particular garment template from a plurality of garment templates based on identification of the garment.

4. The method of claim 1, wherein the initial garment pattern comprises a plurality of two-dimensional (2D) panels joined by a plurality of seams, and the optimization process modifies the plurality of 2D panels.

5. The method of claim 4, wherein each 2D panel comprises a plurality of control handles on one or more boundaries of the 2D panel and a plurality of vertices each having coordinates with respect to the plurality of control handles, and the optimization process modifies the coordinates of the control handles to deform the 2D panel.

6. The method of claim 5, wherein the optimization process uses a loss function that comprises a regularization term to match lengths of the plurality of seams between the plurality of 2D panels and to constrain a curvature of the one or more boundaries of each 2D panel.

7. The method of claim 1, wherein processing the scan data comprises fitting a parametric body model to the scan data.

8. The method of claim 1, wherein the optimization process uses differentiable simulation.

9. The method of claim 1, wherein the scan data comprises a plurality of views of the person from different viewpoints.

10. The method of claim 1, wherein the optimization process estimates the garment material by optimizing for cloth bending properties.

11. The method of claim 1, further comprising using the optimized garment pattern to manufacture a physical garment.

12. The method of claim 1, wherein the optimization process uses a loss function that comprises a feature matching term to match the optimized garment pattern to the scan data.

13. A non-transitory computer-readable medium storing a program for extracting clothing assets, which when executed by a computer, configures the computer to:
receive three-dimensional (3D) scan data characterizing a person wearing a garment;
process the scan data to simultaneously (i) identify from the scan data an initial garment pattern and garment material, and (ii) extract from the scan data an initial pose and an initial body shape;
perform a simulation process based on the initial garment pattern, the garment material, the initial pose, and the initial body shape, to compute an initial 3D garment state;
perform an optimization process on the initial 3D garment state to simultaneously modify one or more of the initial garment pattern, the garment material, the initial pose, and the initial body shape, resulting in an optimized 3D garment state; and
extract, from the optimized 3D garment state, an optimized garment pattern,
wherein the optimization process uses differentiable simulation.

14. The non-transitory computer-readable medium of claim 13, wherein the scan data comprises a 3D mesh, and processing the scan data comprises performing a segmentation process on the 3D mesh to identify the garment.

15. The non-transitory computer-readable medium of claim 14, wherein identifying the initial garment pattern and the garment material comprises selecting a particular garment template from a plurality of garment templates based on identification of the garment.

16. The non-transitory computer-readable medium of claim 13, wherein the initial garment pattern comprises a plurality of two-dimensional (2D) panels joined by a plurality of seams, and the optimization process modifies the plurality of 2D panels.

17. The non-transitory computer-readable medium of claim 16,
wherein each 2D panel comprises a plurality of control handles on one or more boundaries of the 2D panel and a plurality of vertices each having coordinates with respect to the plurality of control handles, and
wherein the optimization process (i) modifies the coordinates of the control handles to deform the 2D panel, and (ii) uses a loss function that comprises a regularization term to match lengths of the plurality of seams between the plurality of 2D panels and to constrain a curvature of the one or more boundaries of each 2D panel.

18. The non-transitory computer-readable medium of claim 13, wherein processing the scan data comprises fitting a parametric body model to the scan data.

19. The non-transitory computer-readable medium of claim 13, wherein the scan data comprises a plurality of views of the person from different viewpoints, and the optimization process uses a loss function that comprises a feature matching term to match the optimized garment pattern to the scan data.

20. The non-transitory computer-readable medium of claim 13, wherein the optimization process estimates the garment material by optimizing for cloth bending properties.
